(19) United States
(12) Patent Application Publication
(10) Pub. No.: US 2014/0022694 A1
(43) Pub. Date: Jan. 23, 2014

(54) METHOD FOR MANUFACTURING HIGH PERFORMANCE MULTILAYER CERAMIC CAPACITORS

(71) Applicants: Glyn Jeremy Reynolds, Largo, FL (US); Robert Mamazza, JR., Buchs (CH)

(72) Inventors: Glyn Jeremy Reynolds, Largo, FL (US); Robert Mamazza, JR., Buchs (CH)

(73) Assignee: OC OERLIKON BALZERS AG, Balzers (LI)

(21) Appl. No.: 13/978,019

(22) PCT Filed: Dec. 30, 2011
(86) PCT No.: PCT/EP2011/074317

§ 371 Date: Oct. 8, 2013

Related U.S. Application Data
(60) Provisional application No. 61/429,577, filed on Jan. 4, 2011.

(51) Int. Cl. H01G 4/12

(52) U.S. Cl. CPC H01G 4/12
USPC 361/301.4; 216/6

(57) ABSTRACT

The invention relates to a method for manufacturing a high performance multi layer ceramic capacitor, comprising the steps of: a) providing a substrate having a first edge and a second edge arranged opposite to the first edge, b) depositing a bottom electrode layer onto the substrate using a thick-film and/or thin-film deposition method such that the electrode layer extends all the way from the first edge towards the second edge of the substrate such that a trench free of the bottom electrode layer is provided adjacent in between the deposited bottom electrode layer and the second edge of the substrate, d) depositing a high-k dielectric ceramic layer onto the electrode layer using a thick-film and/or thin-film deposition method such that the high-k dielectric ceramic layer extends all the way to the first edge and to the second edge of the substrate, f) depositing a low-k dielectric layer comprising silicon nitride, silicon dioxide and/or aluminum oxide onto the high-k dielectric ceramic layer using a thin-film deposition method such that the low-k dielectric layer extends all the way to the first edge and to the second edge of the substrate, h) depositing another electrode layer onto the low-k dielectric layer using a thick-film and/or thin-film deposition method such that the another electrode layer extends all the way to the first edge and to the second edge of the substrate, j) etching the capacitor for cutting a trench through the another electrode layer and through the low-k dielectric layer deposited during steps f) and h) such that the trench is arranged distant to second edge of the substrate, m) cutting the capacitor on both edge sides through the extension of the trenches perpendicular to the extension of the substrate, and n) metalizing both cuffed sides of the capacitor by using a thick-film deposition method.

### TECHNICAL FIELD

This invention relates to the field of electrical energy storage and in particular to multilayer ceramic capacitors with high relative permittivity and high dielectric strength.

### BACKGROUND ART

In 1965, Gordon Moore, one of the founders of Intel, first wrote what later became known as “Moore's Law”. Often misquoted, Dr. Moore in fact made the observation that the complexity for minimum component costs had increased at a rate of roughly a factor of two per year and postulated that this rate was likely to continue in the short term, as described by G. E. Moore in Electronics 38(8), 4 (1965). Moore's Law has paced the rate of semiconductor advances for almost half a century and has given rise to the mantra “smaller, faster, lighter, cheaper” frequently mentioned when pundits speak of the future of integrated circuits (ICs).

However, ICs are not the only electronic components that have witnessed a substantial decrease in critical component size: another example is the essential multilevel ceramic capacitors (MLCCs) often found in close proximity to them on printed circuit boards. In fact, the rate at which capacitance and volumetric efficiency for MLCCs has increased since 1994 has exceeded Moore's Law, doubling approximately every 13-14 months, as described by M. Randall, D. Skamser, T. Kinard, J. Qazi, A. Tajuddin, S. Trolier-McKinstry, C. Randall, S. W. Ko, and T. Dechakupt in CARTS 2007 Symposium Proceedings, Albuquerque, N. Mex., pp. 403-415, March 2007, while recent “Moore's Law” IC performance has doubled every ˜18 months. These rapid advances cannot be maintained ad infinitum.

In order to stay on pace, active layer counts and dielectric permittivity must increase, while dielectric and metal electrode thickness must decrease. This leads to a dilemma: the thick film techniques such as tape casting that are used to manufacturing most of today's MLCCs do not scale well to really small layer thicknesses, while thin film techniques such as sol-gel deposition, chemical vapor deposition (CVD) and physical vapor deposition (PVD) are too expensive to be used to fabricate an active layer count that is rapidly approaching 2,000. Clearly, revolutionary new processing techniques and/or new materials will be required if tomorrow's MLCCs are to achieve the rate of miniaturization needed in the “smaller, faster, lighter, cheaper” electronics of the future.

Another problem posed by decreasing capacitor dielectric layer thickness is increasing electrical leakage and/or dielectric breakdown. The latter can also lead to problems with cycle life. Typically, in order to maintain their electrical integrity, ceramic capacitors should not be subjected to voltages greater than ˜10% of the electric field required for breakdown. While in general, high quality films deposited with sol-gel, CVD or PVD usually exhibit an inverse relation between film thickness and dielectric strength, this only holds down to a certain film thickness. Films deposited with thick film techniques usually require a minimum of four grains across the thickness of the capacitor for reliability purposes.

### DISCLOSURE OF INVENTION

It is the purpose of this invention to describe a manufacturing method that allows high performance MLCCs to be fabricated at a commercially acceptable cost. Moreover, the techniques described herein will enable capacitors so formed to store relatively large amounts of electrical energy in a small volume.

This object is achieved by the independent claims. Advantageous embodiments are detailed in the dependent claims.

Particularly, the object is achieved by a method for manufacturing a high performance multi layer ceramic capacitor, comprising the steps of:
a) providing a substrate having a first edge and a second edge arranged opposite to the first edge,
b) depositing a bottom electrode layer onto the substrate using a thick-film and/or thin-film deposition method such that the electrode layer extends all the way from the first edge towards the second edge of the substrate such that a trench free of the bottom electrode layer is provided adjacent in between the deposited electrode layer and the second edge of the substrate,
d) depositing a high-k dielectric ceramic layer onto the electrode layer using a thick-film and/or thin-film deposition method such that the high-k dielectric ceramic layer extends all the way to the first edge and to the second edge of the substrate,
f) depositing a low-k dielectric layer comprising silicon nitride, silicon dioxide and/or aluminum oxide onto the high-k dielectric ceramic layer using a thin-film deposition method such that the low-k dielectric layer extends all the way to the first edge and to the second edge of the substrate,
h) depositing another electrode layer onto the low-k dielectric layer using a thick-film and/or thin-film deposition method such that the another electrode layer extends all the way to the first edge and to the second edge of the substrate,
j) etching the capacitor for cutting a trench through the another electrode layer and through the low-k dielectric layer deposited during steps f) and h) such that the trench is arranged distant to second edge of the substrate,
m) cutting the capacitor on both edge sides through the extension of the trenches perpendicular to the extension of the substrate, and
n) metalizing both cutted sides of the capacitor by using a thick-film deposition method.

According to another preferred embodiment of the invention, the method further comprises the steps of:
k) repeat steps d) to h) and thereafter etching the capacitor for cutting a trench through the another electrode layer deposited during the repeated step f) and through the low-k dielectric layer deposited during the repeated step h) such that the trench is arranged adjacent to the second edge of the substrate.

According to another preferred embodiment of the invention, the method further comprises the step of:
repeat steps d) to k).

According to another preferred embodiment of the invention, the method further comprises the steps of
c) heat treating the bottom electrode layer, preferably within a vacuum environment and/or within a reducing pressure environment,
e) heat treating the high-k dielectric ceramic layer at a first temperature, preferably within a vacuum environment and/or within a reducing pressure environment, and more preferably thereafter heat treating the high-k dielectric ceramic layer at a second temperature that is lower than the first temperature in an oxidizing ambient,
g) cooling the capacitor, and/or
i) heat treating the another electrode layer, preferably within a vacuum environment and/or within a reducing pressure environment,

According to another preferred embodiment of the invention, the dielectric layers deposited during steps d) and f) are deposited such that the thickness of the low-k dielectric layer is ≦5% of the thickness of the high-k dielectric ceramic layer.

According to another preferred embodiment of the invention, the thick-film deposition method comprises screen printing and/or tape casting.

According to another preferred embodiment of the invention, the thin-film method deposition comprises sol-gel deposition, sputtering, evaporation, ion plating, pulsed laser deposition, atomic layer deposition, chemical vapor deposition, plasma-enhanced chemical vapor deposition, electrografting, electroplating and/or electroless plating.

According to another preferred embodiment of the invention, the substrate comprises a metal, a ceramic and/or a glass, preferably alumina, mullite, quartz, silicon, a refractory metal foil, most preferably nickel or nickel alloys.

According to another preferred embodiment of the invention, the electrode layer comprises nickel, copper, platinum, iridium, rhodium, palladium and/or alloys of palladium and/or of silver.

The object of the invention is further addressed by a high performance multi layer ceramic capacitor, comprising
a substrate having a first edge and a second edge arranged opposite to the first edge,
a bottom electrode layer deposited onto the substrate such that the bottom electrode layer extends all the way from the first edge towards the second edge of the substrate such that a trench free of the bottom electrode layer is provided adjacent in between the deposited electrode layer and the second edge of the substrate,
a high-k dielectric ceramic layer deposited onto the electrode layer such that the high-k dielectric ceramic layer extends all the way to the first edge and to the second edge of the substrate,
a low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the low-k dielectric layer is provided adjacent in between the deposited low-k dielectric layer and the first edge of the substrate,
another electrode layer deposited onto the low-k dielectric layer such that the another electrode layer extends all the way from the first edge towards the second edge of the substrate such that a trench free of the another electrode layer is provided adjacent in between the deposited another electrode layer and the first edge of the substrate,
a first metalized electrode arranged perpendicular to the extension of the substrate at the first edge of the substrate and in electrical contact with the bottom electrode layer, and
a second metalized electrode arranged perpendicular to the extension of the substrate at the second edge of the substrate and in electrical contact with the another electrode layer.

According to another preferred embodiment of the invention, the capacitor further comprises
a first layer set of
   a first high-k dielectric ceramic layer deposited onto the another electrode layer such that the high-k dielectric ceramic layer extends all the way to the first edge and second edge of the substrate,
   a first low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the first low-k dielectric layer is provided adjacent in between the deposited first low-k dielectric layer and the second edge of the substrate, and
   a first electrode layer deposited onto the low-k dielectric layer such that the another electrode layer extends all the way from the first edge towards the second edge of the substrate such that a trench free of the first electrode layer is provided adjacent in between the deposited first electrode layer and the second edge of the substrate,
and a second layer set of
   a second high-k dielectric ceramic layer deposited onto the first electrode layer such that the high-k dielectric ceramic layer extends all the way to the first edge and second edge of the substrate,
   a second low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the second low-k dielectric layer is provided adjacent in between the deposited second low-k dielectric layer and the first edge of the substrate, and
   a second electrode layer deposited onto the low-k dielectric layer such that the another electrode layer extends all the way from the first edge towards the second edge of the substrate such that a trench free of the second electrode layer is provided adjacent in between the deposited second electrode layer and the first edge of the substrate, whereby
the first metalized electrode is arranged adjacent and in electrical contact with all electrode layers that comprise a trench adjacent to the second edge of the substrate, and
the second metalized electrode is arranged adjacent and in electrical contact with all electrode layers that comprise a trench adjacent to the first edge of the substrate.

According to another preferred embodiment of the invention, the capacitor further comprises a plurality of first and second layer sets arranged each on top of each other.

According to another preferred embodiment of the invention, the thickness of the low-k dielectric layer is ≦5% of the thickness of the high-k dielectric layer.

According to another preferred embodiment of the invention, the low-k dielectric layer is deposited by sol-gel deposition, sputtering, evaporation, ion plating, pulsed laser deposition, atomic layer deposition, chemical vapor deposition, plasma-enhanced chemical vapor deposition, electrografting, electroplating and/or electroless plating.

### BRIEF DESCRIPTION OF DRAWINGS

These and other aspects of the invention will be apparent from and elucidated with reference to the embodiments described hereinafter.

In the drawings:

FIG. 1-4 show the steps for manufacturing a high performance multi layer ceramic capacitor stack according to a preferred embodiment of the invention,

FIG. 5 shows the step of cutting the capacitor stack according to the preferred embodiment of the invention, and

FIG. 6 shows the steps of metalizing the cutted capacitor stack according to the preferred embodiment of the invention.

### DETAILED DESCRIPTION OF DRAWINGS

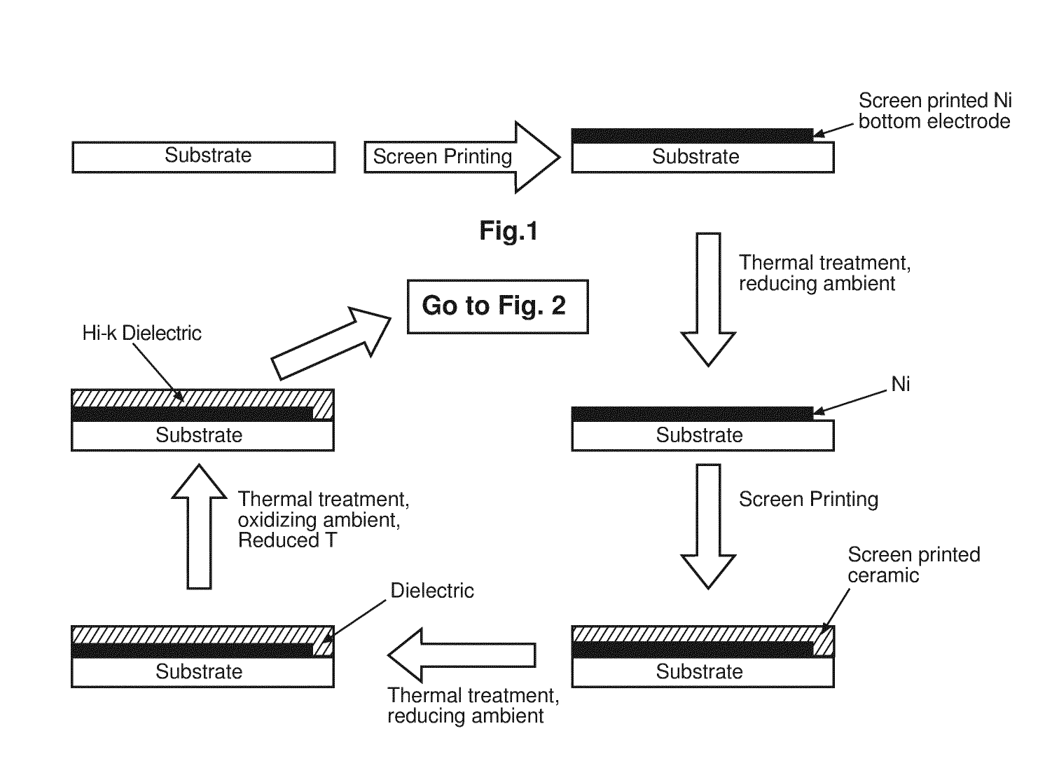

It is instructive to look at the figures to understand the invention described herein. FIG. 1 through 4 of the drawings provide a schematic illustration of our proposed method for manufacturing a basic unit of a multilayer ceramic capacitor. Referring to FIG. 1, the process starts with a substrate; this can be a metal, a ceramic or a glass capable of withstanding the maximum temperature to which the capacitor structure will be exposed during processing. Some examples of suitable substrates are alumina, mullite, quartz, silicon, refractory metal foils, e.g., Ni and its high melting point alloys, etc. Other suitable substrates will be known to those skilled in the art. A bottom electrode material is applied to the substrate. For this, base metals such as Ni and Cu are preferred for cost reasons but other metals such as the noble metals, e.g. Pt, Ir, Rh, Pd, as well as alloys of Pd and Ag are also known to be effective by those skilled in the art. Again, for cost reasons, thick film methods such as screen printing or tape casting are preferred but where electrode layer thinness is paramount, thin-film techniques including but not limited to sputtering, evaporation, ion plating, pulsed laser deposition, atomic layer deposition, chemical vapor deposition, plasma-enhanced chemical vapor deposition, electroplating and electroless plating can be employed. The metal electrode layer should be continuous which places a lower limit on the thickness at around 5 nm for most thin film techniques; the minimum thickness possible by thick film techniques will typically be greater by between 1 and 2 orders of magnitude.

If desired, the bottom electrode can be now be heat treated to increase its density and/or to remove the organic and volatile components of the inks and binders used, for example, in the screen printing process. Where base metal electrodes such as Ni and/or Cu are present, this must be performed in vacuum or in another reducing environment. Alternatively, the heat treatment steps for the electrodes and the ceramic dielectric layers can be combined. Electrode layers deposited by sputtering at several hundred degrees Celsius are usually of high density and low resistivity and typically will not require a post-deposition heat treatment prior to depositing the dielectric. In a preferred embodiment, the bottom electrode should be deposited so as to extend all the way to one edge of the substrate but should not extend completely to the opposite edge: this pattern is easily achieved by screen printing or by PVD through a shadow mask.

Following deposition of the bottom electrode, the ceramic dielectric is deposited. Again, this can be by thick film techniques such as screen printing or tape casting that are preferred for cost reasons but where dielectric layer thinness is paramount, thin-film techniques including but not limited to sol-gel deposition, sputtering, evaporation, ion plating, pulsed laser deposition, atomic layer deposition, chemical vapor deposition, plasma-enhanced chemical vapor deposition and “electrografting” can be employed. In most cases, a post-deposition heat treatment of the ceramic dielectric will be required—a high temperature firing in vacuum or in a reducing environment to remove the organic and volatile components of the inks and binders used, for example, in the screen printing process and also to form the desired crystal and grain structures for high-k materials such as doped barium titanates that must be converted to their perovskite phase. Often, a second heat treatment at lower temperature in an oxidizing ambient is performed to anneal out any oxygen vacancies formed in the dielectric during high temperature processing and that can give rise to electrical leakage in the capacitor. It should be noted that if noble metal electrodes are used, it is not necessary to perform a two step anneal—a single high temperature firing in a controlled oxidizing ambient is usually sufficient. In addition, the introduction of certain dopants into high-k dielectrics such as barium titanate can obviate the requirement for the second firing step described above by compensating for any oxygen vacancies in the lattice. Furthermore, high temperature, typically >600° C., sputtering and CVD methods usually deposit doped barium titanates in the desired perovskite phase, thereby reducing the maximum post-deposition firing temperature of the dielectric. In principle, the use of noble metal electrodes with certain doped dielectrics deposited by high temperature PVD or CVD can dispense with the requirement for heat treatment entirely.

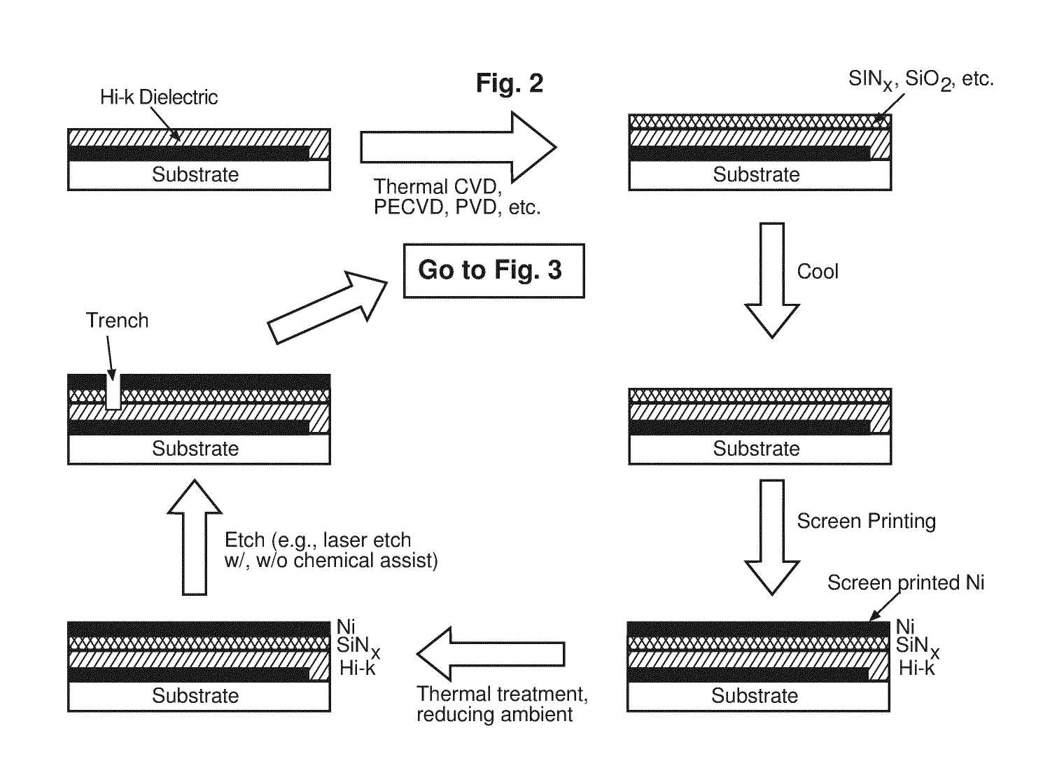

Continuing the sequence onto FIG. 2, the high-k ceramic is now coated with a high quality, high integrity thin-film such as silicon nitride (SiNₓ), silicon dioxide (SiO₂), aluminum oxide (Al₂O₃), etc. In their thin-film forms, these films are known to combine superior dielectric strengths (typically >5MV/cm) with low electrical leakage, albeit their relative permittivities are very low in comparison to materials such as barium titanate and related compounds. These thin-films should be continuous—in practice, they will probably have thicknesses ≧5 nm—but consistent with this requirement, where practical, they can be even thinner. Suitable deposition techniques include sol-gel deposition, sputtering, evaporation, ion plating, pulsed laser deposition, atomic layer deposition, plasma-enhanced chemical vapor deposition, “electrografting” and especially chemical vapor deposition deposited at or near atmospheric pressure, thereby dispensing with the need for expensive vacuum equipment. Atmospheric CVD also lends itself very well to continuous processing, either using reel-to-reel processes that would be compatible with, for example, metal foil substrates or by using a system where the substrates are placed on a belt or similar apparatus and passed through a single or multi-zone furnace where the deposition carried out. It is critical to control the relative thicknesses of the high-k dielectric and the high breakdown strength dielectric very carefully because if the low-k, high strength dielectric is too thick, the two dielectric capacitor will behave as two capacitors in series and the resulting capacitance will be dominated by the low-k, low capacitance dielectric according to the equation:

C_{Total}={C_{Hi-k}+C_{Lo-k}}/C_{Hi-k}·C_{Lo-k}

where C_{Total} is the total capacitance of the two layer structure, C_{Hi-k} is the capacitance due to the high-k dielectric and C_{Lo-k} is the capacitance due to the low-k dielectric. However, in cases where the thickness of the low-k dielectric is ˜5% or lower than the thickness of the high-k layer, then modeling of the composite structure by analytical and numerical methods predicts that the overall composite will behave primarily as a capacitor with a large capacitance, rapidly approaching C_{Hi-k} as the volume fraction of the high-k dielectric tends to 100%. This result has been verified experimentally by measurements on composite capacitors that contained large volume fractions of high-k material in a low-k matrix that comprised <5% of the total dielectric volume. For fabricating the optimum structure, atmospheric CVD is again preferred because thermal CVD is able to penetrate into very small spaces, even between the gaps of the individual high-k grains. In this way, an internal barrier-layer type capacitor dielectric is formed with a large capacitance but with reduced leakage and increased dielectric breakdown strength. Due to the required thinness of the high breakdown material, it can be deposited relatively quickly and therefore relatively inexpensively.

The preferred embodiment described that proposes the use of a continuous processing atmospheric, or near atmospheric, CVD deposition system with multi-zone furnaces lends itself very well to fully automated manufacturing. Following deposition of the ceramic, the substrates can be introduced into a multi-zone furnace where the first high temperature zone incorporates a reducing ambient, the second zone incorporates a controlled oxidizing ambient and the third zone incorporates the deposition process: suitable gas curtains separate each zone from the one prior. Different zones can be regulated at different temperatures as practiced by those skilled in the art.

After deposition the capacitor stack is allowed to cool and a second layer of Ni or other suitable metal electrode material is deposited according to the techniques already described. Optionally, this layer can be subjected to post-deposition heat treatment if desired. At this point, the capacitor structure is introduced into a suitable apparatus for etching. This is most economically performed with a laser, with or without chemical assist. The laser power and raster speed should be adjusted so as to cut a trench through the Ni, or other metal electrode layer, and through the thin layer of low-k dielectric. In this manner, a series of parallel trenches can be etched across the whole substrate, thereby preparing the structure for eventual singulation into MLCCs of the requisite size. Alternatively, the capacitor stack can be lithographically patterned and etched in a reactive ion etcher or plasma etcher, or by wet chemical methods but this increases complexity and hence overall cost. Moreover, both chemical and plasma etching of noble metals is difficult; plasma etching is also not well-suited to Ni and Cu electrodes as few sufficiently volatile etch products are known for these metals.

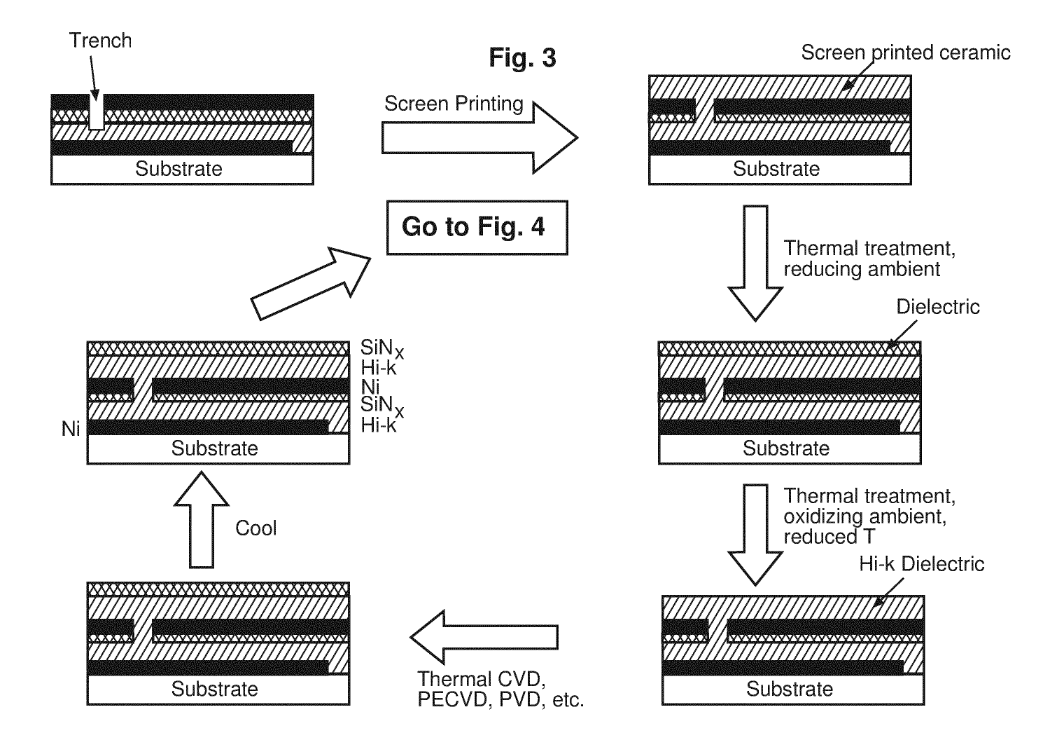

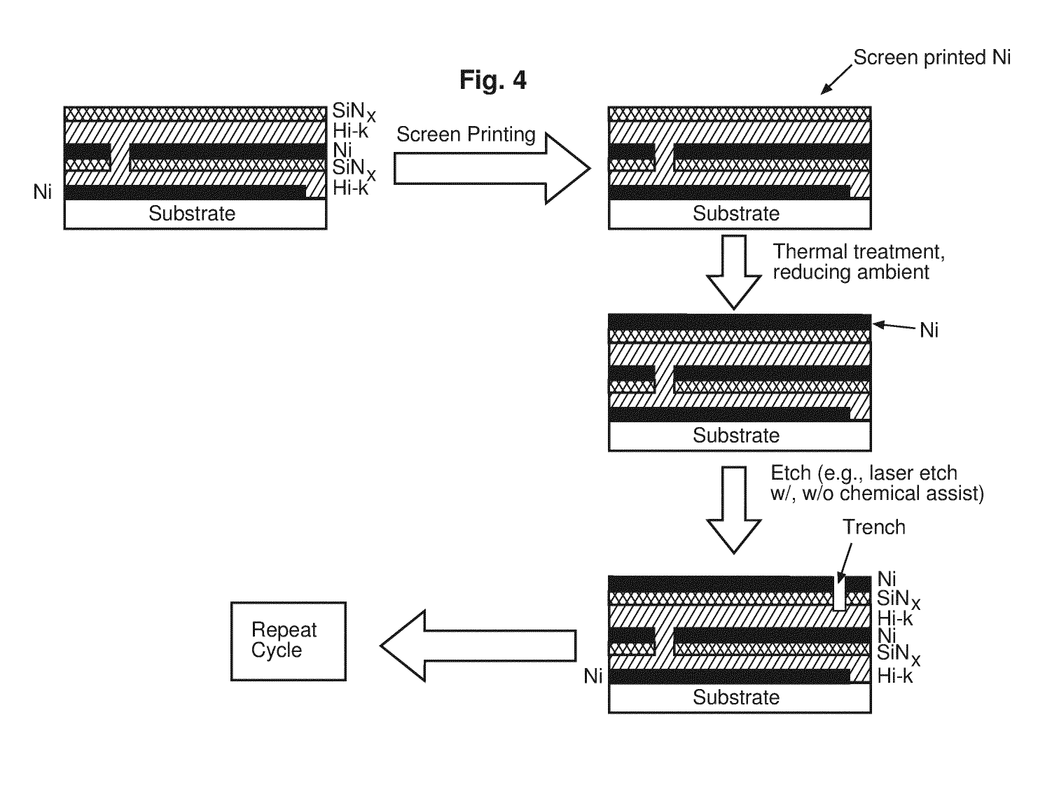

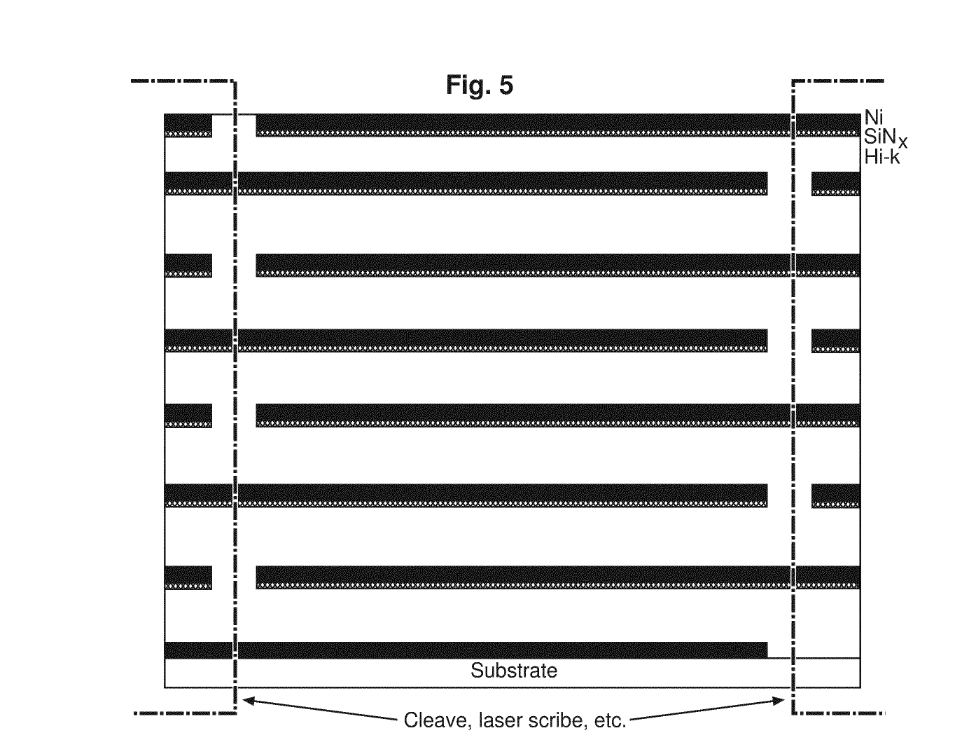

Referring to FIG. 3, after the trenches are etched, a second layer of high-k ceramic is deposited onto the second metal electrode according to the techniques previously described herein, taking particular care to fill the trench etched in the prior step. After appropriate heat treatment(s), a second high quality, high integrity thin-film is deposited as described previously. This, in turn, is followed by additional metal deposition with or without subsequent heat treatment and another etching step is performed to cut a trench through the third metal electrode and through the second low-k dielectric immediately below it. In this second etch step, the trenches should be offset from the first array of trenches as shown schematically on FIG. 4. The distance between the center-line of the two trenches will correspond to the length of one side of the MLCC device after singulation. Subsequent etched trenches should be aligned directly above either the first trench (for odd numbered etch steps) or second trench (for even numbered etch steps). This overall process sequence is repeated until the desired number of capacitor layers is reached. Ultimately, a structure such as that shown schematically on FIG. 5 will result (in this figure, only 7 layers are shown but in principle, the method described here could be used to fabricate capacitors with thousands of layers as needed). At this point, the structure should be cleaved or cut through the center-line of the trenches by methods known to those skilled in the art to produce a series of strips of the substrate, each containing a wide, narrow MLCC.

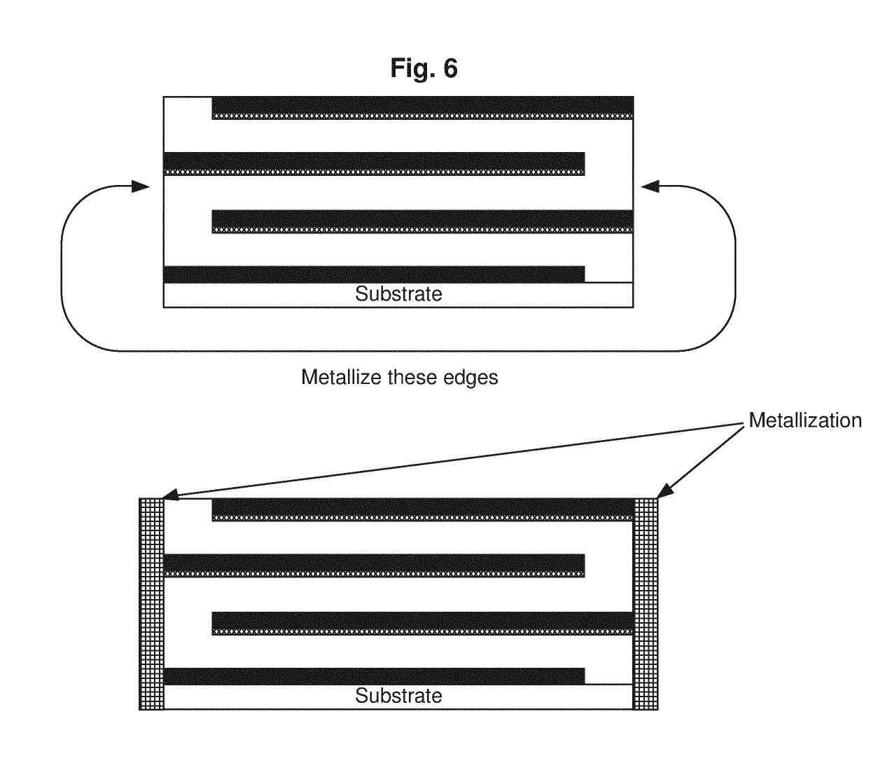

Opposing faces of these strips are then metallized by methods known to those skilled in the art, including but not limited to sputtering, evaporation, ion plating, pulsed laser deposition, atomic layer deposition, chemical vapor deposition, plasma-enhanced chemical vapor deposition, electroplating and electroless plating, —see FIG. 6. Finally, these strips are cut perpendicular to the direction of the trenches and packaged according to known methods. At this stage, the substrate can be thinned or removed entirely by polishing, chemical-mechanical polishing, etching or similar means.

In addition to increasing the overall dielectric strength and reducing the electrical leakage of conventionally fabricated MLCCs, the method described here that combines thick film and thin-film deposition techniques can also be used to advantage in other ways. For example, MLCCs fabricated with thick film means reportedly require at least four grains of high-k dielectric between adjacent electrodes, as described by M. Randall, D. Skamser, T. Kinard, J. Qazi, A. Tajuddin, S. Trolier-McKinstry, C. Randall, S. W. Ko, and T. Dechakupt in CARTS 2007 Symposium Proceedings, Albuquerque, N. Mex., pp. 403-415, March 2007. Thin-film processes such as CVD and/or PVD could be used to deposit high quality, high integrity, small-grained layers on top of similar thicker layers deposited by tape casting or screen printing, thus allowing the overall thickness of the dielectric in each layer to be reduced. Depositing the whole dielectric layer by thin-film techniques would be much slower and therefore more costly.

The method described herein also allows for the use of novel high-k capacitor dielectrics that would otherwise prove too leaky. For example, the material CaCu₃Ti₄O₁₂ (CCTO) has a reported relative permittivity close to 100,000, as described by C. C. Homes, T. Vogt, S. M. Shapiro, S. Wakimoto and A. P. Ramirez in Science 293, 673, 2001, but it has too high an electrical conductivity for application as a capacitor dielectric. By building structures with very thin electrically blocking layers. e.g., SiNₓ, SiO₂, Al₂O₃, etc., ideally deposited by thermal CVD or by techniques that will allow the high strength dielectrics to infiltrate into the grain structure, MLCCs using CCTO, related doped compounds or other ultra-high k materials could be envisioned.

An alternative embodiment to the method described herein is the use of chemical vapor infiltration (CVI) to create a composite structure consisting of high-k dielectric material surrounded by a matrix of high breakdown strength, electrically insulating material. This CVI process could be performed before, during or after one or both of the high temperature firing/anneal steps of the high-k ceramic dielectric described earlier.

While the invention has been illustrated and described in detail in the drawings and foregoing description, such illustration and description are to be considered illustrative or exemplary and not restrictive; the invention is not limited to the disclosed embodiments. Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. Method for manufacturing a high performance multilayer ceramic capacitor, comprising the steps of:
a) providing a substrate having a first edge and a second edge arranged opposite to the first edge,
b) depositing a bottom electrode layer onto the substrate using a thick-film and/or thin-film deposition method such that the electrode layer extends all the way from the first edge towards the second edge of the substrate such that a trench free of the bottom electrode layer is provided adjacent in between the deposited bottom electrode layer and the second edge of the substrate,
d) depositing a high-k dielectric ceramic layer onto the electrode layer using a thick-film and/or thin-film deposition method such that the high-k dielectric ceramic layer extends all the way to the first edge and to the second edge of the substrate,
f) depositing a low-k dielectric layer comprising silicon nitride, silicon dioxide and/or aluminum oxide onto the high-k dielectric ceramic layer using a thin-film deposition method such that the low-k dielectric layer extends all the way to the first edge and to the second edge of the substrate,
h) depositing another electrode layer onto the low-k dielectric layer using a thick-film and/or thin-film deposition method such that the another electrode layer extends all the way to the first edge and to the second edge of the substrate,
j) etching the capacitor for cutting a trench through the another electrode layer and through the low-k dielectric layer deposited during steps f) and h) such that the trench is arranged distant to second edge of the substrate,
m) cutting the capacitor on both edge sides through the extension of the trenches perpendicular to the extension of the substrate, and
n) metalizing both cutted sides of the capacitor by using a thick-film deposition method.

2. Method according to claim 1, comprising the further steps of:
k) repeating steps d) to h) and thereafter etching the capacitor for cutting a trench through the another electrode layer deposited during the repeated step f) and through the low-k dielectric layer deposited during the repeated step h) such that the trench is arranged adjacent to the second edge of the substrate.

3. Method according to claim 1, comprising the further step of:
repeating steps d) to k).

4. Method according to claim 1, comprising any of the further steps of:
c) heat treating the bottom electrode layer, preferably within a vacuum environment and/or within a reducing pressure environment,
e) heat treating the high-k dielectric ceramic layer at a first temperature, preferably within a vacuum environment and/or within a reducing pressure environment, and more preferably thereafter heat treating the high-k dielectric ceramic layer at a second temperature that is lower than the first temperature in an oxidizing ambient.
g) cooling the capacitor, and/or
i) heat treating the another electrode layer, preferably within a vacuum environment and/or within a reducing pressure environment.

5. Method according to claim 1, wherein the dielectric layers deposited during steps d) and f) are deposited such that the thickness of the low-k dielectric layer is ≦5% of the thickness of the high-k dielectric ceramic layer.

6. Method according to claim 1, wherein the thick-film deposition method comprises screen printing and/or tape casting.

7. Method according to claim 1, wherein the thin-film method deposition comprises sol-gel deposition, sputtering, evaporation, ion plating, pulsed laser deposition, atomic layer deposition, chemical vapor deposition, plasma-enhanced chemical vapor deposition, electrografting, electroplating and/or electroless plating.

8. Method according to claim 1, wherein the substrate comprises a metal, a ceramic and/or a glass, preferably alumina, mullite, quartz, silicon, a refractory metal foil, most preferably nickel or nickel alloys.

9. Method according to claim 1, wherein the electrode layer comprises nickel, copper, platinum, iridium, rhodium, palladium and/or alloys of palladium and/or of silver.

10. High performance multi layer ceramic capacitor, comprising
a substrate having a first edge and a second edge arranged opposite to the first edge,
a bottom electrode layer deposited onto the substrate such that the bottom electrode layer extends all the way from the first edge towards the second edge of the substrate such that a trench free of the bottom electrode layer is provided adjacent in between the deposited bottom electrode layer and the second edge of the substrate,
a high-k dielectric ceramic layer deposited onto the electrode layer such that the high-k dielectric ceramic layer extends all the way to the first edge and to the second edge of the substrate,
a low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the low-k dielectric layer is provided adjacent in between the deposited low-k dielectric layer and the first edge of the substrate,
another electrode layer deposited onto the low-k dielectric layer such that the another electrode layer extends all the way from the first edge towards the second edge of the substrate such that a trench free of the another electrode layer is provided adjacent in between the deposited another electrode layer and the first edge of the substrate,
a first metalized electrode arranged perpendicular to the extension of the substrate at the first edge of the substrate and in electrical contact with the bottom electrode layer, and
a second metalized electrode arranged perpendicular to the extension of the substrate at the second edge of the substrate and in electrical contact with the another electrode layer.

11. Capacitor according to claim 10, further comprising a first layer set of
a first high-k dielectric ceramic layer deposited onto the another electrode layer such that the high-k dielectric ceramic layer extends all the way to the first edge and second edge of the substrate,
a first low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the first low-k dielectric layer is provided adjacent in between the deposited first low-k dielectric layer and the second edge of the substrate, and
a first electrode layer deposited onto the low-k dielectric layer such that the another electrode layer extends all the way from the first edge towards the second edge of the substrate such that a trench free of the first electrode layer is provided adjacent in between the deposited first electrode layer and
the second edge of the substrate, and a second layer set of
a second high-k dielectric ceramic layer deposited onto the first electrode layer such that the high-k dielectric ceramic layer extends all the way to the first edge and second edge of the substrate,
a second low-k dielectric layer comprising silicon nitride, silicon dioxide and/or aluminum oxide deposited onto the high-k dielectric ceramic layer such that the low-k dielectric layer extends all the way from the first edge towards the second edge of the substrate such that a trench free of the second low-k dielectric layer is provided adjacent in between the deposited second low-k dielectric layer and the first edge of the substrate, and
a second electrode layer deposited onto the low-k dielectric layer such that the another electrode layer extends all the way from the first edge towards the second edge of the substrate such that a trench free of the second electrode layer is provided adjacent in between the deposited second electrode layer and the first edge of the substrate, whereby the first metalized electrode is arranged adjacent and in electrical contact with all electrode layers that comprise a trench adjacent to the second edge of the substrate, and
the second metalized electrode is arranged adjacent and in electrical contact with all electrode layers that comprise a trench adjacent to the first edge of the substrate.

12. Capacitor according to claim 11, comprising a plurality of first and second layer sets arranged each on top of each other.

13. Capacitor according to claim 10, whereby the thickness of the low-k dielectric layer is ≦5% of the thickness of the high-k dielectric layer.

14. Capacitor according to claim 10, whereby the low-k dielectric layer is deposited by sol-gel deposition, sputtering, evaporation, ion plating, pulsed laser deposition, atomic layer deposition, chemical vapor deposition, plasma-enhanced chemical vapor deposition, electrografting, electroplating and/or electroless plating.
